(19) United States
(12) Patent Application Publication
(10) Pub. No.: US 2006/0294572 A1
(43) Pub. Date: Dec. 28, 2006

(54) System and method to promptly startup a networked television

(75) Inventor: Edward Walter, Boeme, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/436,252

(22) Filed: May 16, 2006

Related U.S. Application Data
(63) Continuation-in-part of application No. 11/166,909, filed on Jun. 24, 2005.

(51) Int. Cl. H04N 7/16; H04N 7/173; H04N 7/167

(52) U.S. Cl. 725/140; 725/100; 725/31; 725/131; 725/132; 725/141; 725/152

(57) ABSTRACT

In an embodiment, a system includes a processor and a network interface coupled to the processor. The network interface is further coupled to a packet-based network. The processor is further connected to a television display, a decoder, and a flash memory. The decoder is also connected to the network interface. The processor is configured to execute a real-time operating system which has logic and configuration parameters for streamlining one or more operations of the processor.

### RELATED APPLICATIONS

This application is a continuation-in-part, and claims priority to U.S. patent application Ser. No. 11/166,909, filed on Jun. 24, 2005, and entitled “Network Television and Method Thereof”; U.S. patent application Ser. No. 11/166,785, filed on Jun. 24, 2005, and entitled “Multi-Media Based Video Game Distribution”; U.S. patent application Ser. No. 11/166,908, filed on Jun. 24, 2005, and entitled “Video Game Console Modular Card and Method Thereof”; and U.S. patent application Ser. No. 11/166,907, filed on Jun. 24, 2005, and entitled “Audio Receiver Modular Card and Method Thereof.” Each of the foregoing patent applications is hereby incorporated by reference in their entirety for all purposes.

### TECHNICAL FIELD

Various embodiments relate to processing and displaying multimedia data received via a network on a television.

### BACKGROUND

Television has become an integral part of the lives of most consumers. Until recently, television content was provided only as an analog signal either by means of a wireless transmission (e.g., broadcast network television) or via coaxial cable (e.g., cable television). However, as viewers turn to higher quality video and demand additional features, such as video on demand, content providers have begun to rely on digital solutions, such as video streaming over networks or digital cable transmissions. While these digital solutions often provide many of the features sought by consumers, they typically require the consumer to invest in expensive and complex equipment.

For example, consumers typically must utilize a personal computer (PC) to receive and display video content streamed or otherwise provided by a computer network. However, PCs are designed to support a wide variety of functions, from Internet browsing and word processing to the processing of detailed and complex scientific data. As such, PCs implement complex hardware architectures and sophisticated operating systems in order to be capable of supporting the widely divergent tasks expected of them. The complexity of PCs results in a user experience that is different from the traditional television experience in that they often require a substantial amount of time to boot up before they can be operated by a user, whereas conventional televisions typically are ready to provide video content almost immediately. Additionally, with their multitude of exposed cables and constant fan noise, PCs often present an unaesthetic solution for television viewing. Similarly, the set top boxes (STB's) typically required for receiving and processing digital cable transmissions often detract from the visual appeal of the television setting. Moreover, as opposed to PCs, conventional STB's typically are of limited functionality in that they typically interface with only coaxial cable connections and provide functions directed to processing video and audio content of a cable television transmission.

### BRIEF DESCRIPTION OF THE DRAWINGS

Various embodiments are pointed out with particularity in the appended claims. However, other features are described in the following detailed description in conjunction with the accompanying drawings in which:

FIG. 1 illustrates an embodiment of a networked television.

FIG. 2 illustrates a block diagram of an architecture of the networked television of FIG. 1.

FIG. 3 illustrates a block diagram of an embodiment of a multimedia decoder modular card architecture.

FIG. 4 illustrates an example embodiment of a television display including a primary image and several secondary images.

FIG. 5 illustrates an example embodiment of a networked television coupled to a network.

FIG. 6 illustrates an embodiment of a process to configure and operate a networked television.

FIG. 7 illustrates an embodiment of a computer architecture upon which an embodiment of a networked television may operate.

### DETAILED DESCRIPTION

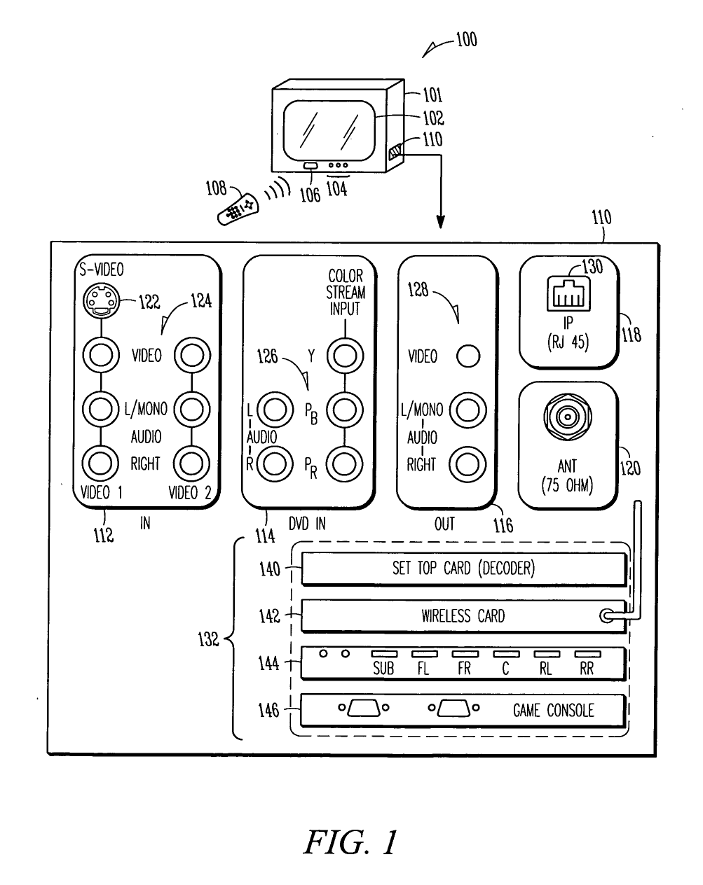

Referring to FIG. 1, an exemplary networked television 100 is illustrated in accordance with at least one embodiment of the present disclosure. As depicted, the television 100 includes a housing 101 that contains a display 102 (e.g., a liquid crystal display or a plasma display). Further, the housing 101 includes a plurality of user interface buttons 104, such as a power button, channel change buttons, volume control buttons, and the like. The housing 101 also includes a remote control interface 106, for example an infrared interface or a radio frequency (RF) interface, to receive remote control commands from a remote control 108. In a particular embodiment, one or more operations of the television 100 are responsive to the remote control commands. The television 100 further includes an interface panel 110 that is accessible via an external surface of the housing 101, for example at a top, back or side surface of the housing 101. The interface panel 110 includes one or more interfaces for receiving or outputting various forms of multimedia data. As shown, the interface panel 110 includes an IN component 112 that includes, for example, an S-video receptacle 122 and audio-visual receptacles 124, and a digital versatile disk (DVD) IN component 114 that is configured to receive video data and audio data from an external DVD player or other multimedia source. In particular, the DVD IN component 114 includes a plurality of receptacles 126 that can receive component video and audio. The panel 110 also can include an OUT component 116 that has receptacles 128 to provide video data and/or audio data to another television or recording device, such as a personal video recorder (PVR) or an external DVD player/recorder. An RF antenna receptacle 120 also can be incorporated into the panel 110 to receive multimedia data via RF transmissions.

In at least one embodiment, the panel 110 further includes a network interface 118 that includes a network receptacle 130 that can be connected to any of a variety of packet-based data networks. The receptacle 130 can be connected to an Internet Protocol (IP)-based network, for example an Ethernet network or an asynchronous transfer mode (ATM)-based network. Further, in a particular embodiment, the network interface 118 can include an Ethernet interface, and as such, the network receptacle 130 can be an RJ-45 receptacle that is configured to receive an Ethernet cable that is connected to an Ethernet-based network. The television 100 can utilize the network interface 118 to receive multimedia data, for example video data, audio data, or video game data, over a packet-based network for processing at the television 100. Moreover, the network interface 118 may be used by the television 100 to forward information to another networked device, such as another networked television 100. The forwarded information may include, for example, processed multimedia data or information associated with the multimedia data, information associated with a video game being played at the television 100, and the like.

As illustrated in FIG. 1, the panel 110 further can include one or more modular card receptacles 132 (also commonly referred to as “expansion slots”) to interface with one or more modular cards (also commonly referred to as “expansion cards”) to enhance the functionality of the television 100. The modular cards can include, for example, a multimedia decoder modular card 140, a wireless network interface modular card 142, an audio receiver modular card 144, a video game console modular card 146, and the like. In a particular embodiment, the modular card receptacles 132 and the corresponding modular cards 140, 142, 144, and 146 may be implemented using a standard architecture, such as a Peripheral Component Interconnect (PCI)-compliant architecture, an Industry Standard Architecture (ISA)-compliant architecture, or a Personal Computer Memory Card International Association (PCMCIA)-compliant architecture. Alternatively, the modular card receptacles 132 and the corresponding modular cards 140, 142, 144, and 146 may be implemented using a proprietary architecture, or a combination of standard and proprietary architectures.

To customize the functionality of the television 100, modular cards may be added or removed from the television by inserting or removing the modular cards from their corresponding modular card receptacles. For example, the panel 110 may include an opening in the housing for each modular card receptacle 132 and each modular card receptacle 132 may receive a modular card that is inserted through the corresponding opening so that the contacts of the modular card receptacle interface are brought into secure contact with the contacts of the receiving modular card receptacle 132. Alternatively, part or all of the panel 110 can be temporarily removed to install the modular card in a modular card receptacle 132. In at least one embodiment, some or all of the modular cards may include one or more interface receptacles that are accessible at the panel 110 to interface with other components.

In a particular embodiment, the incorporation of one or more modular cards into the television 100 allows for an expansion of the available functionality of the television 100. For example, the television 100 may incorporate the wireless network interface modular card 142 to provide wireless connectivity for the transmission of information to other networked devices. Moreover, the television 100 may incorporate the multimedia decoder modular card 140 to process multimedia data. The processing performed by the multimedia decoder modular card 140 may include, for example, decoding or transcoding encoded multimedia data, encoding unencoded multimedia data, decrypting encrypted multimedia data, and the like.

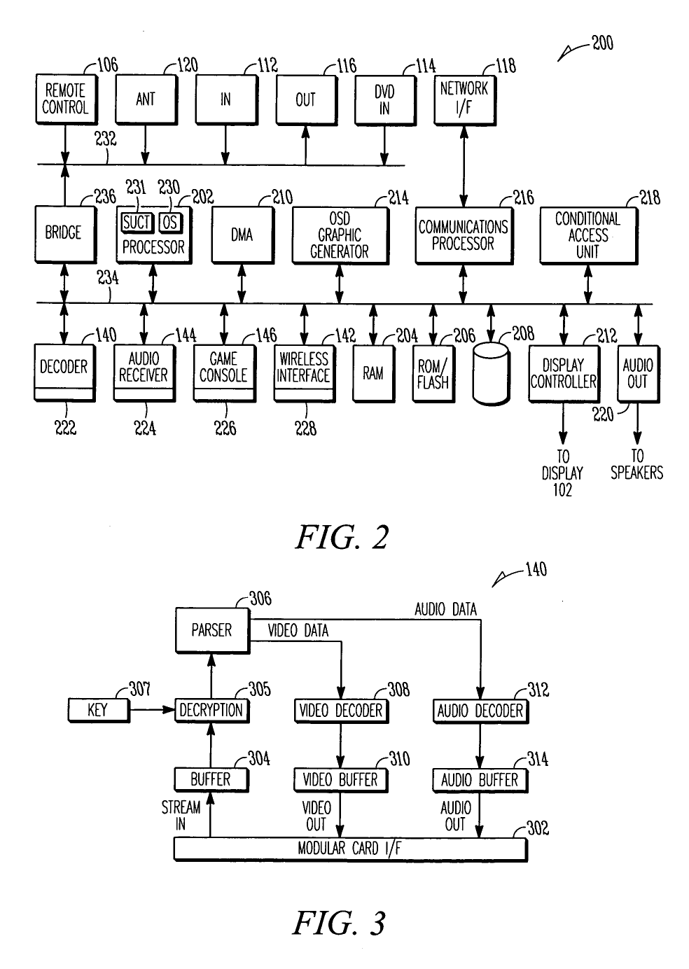

Referring to FIG. 2, an example embodiment of an architecture 200 of the television 100 is illustrated in accordance with at least one embodiment of the present disclosure. The television 100 includes one or more processors 202 (which in an embodiment may be referred to as television-based processors), one or more storage devices, such as a random access memory (RAM) 204, a read only memory (ROM) or flash memory 206 or a hard disk 208, a direct memory access controller (DMA) 210 and a display controller 212 coupled to the display 102 (FIG. 1). The television 100 also can include an overlay graphics generator 214, a network communications processor 216 connected to the network interface 118, a conditional access unit 218, and an audio output 220. The television 100 further can include modular card receptacles 222, 224, 226, and 228 connected to the multimedia decoder modular card 140, the audio receiver modular card 144, the video game console modular card 146, and the wireless network interface modular card 142, respectively. As depicted in FIG. 2, the television 100 can further include the remote control interface 106, the RF antenna interface 120, the IN component 112, the OUT component 116, and the DVD IN component 114 of the panel 110 (FIG. 1). In the illustrated example, some components of the television 100 can be connected to a first bus 232 while other components can be connected via a second bus 234. Further, the busses 232, 234 can be connected by a bridge bus 236.

The processor 202 can perform multimedia processing routines in accordance with an operating system (OS) 230 and can facilitate the functions performed by the modular cards that are connected to the modular card receptacles 222-228 of the television 100 by routing information between the components or by handling various aspects of the functions performed by the modular cards. In a particular embodiment, in order to provide prompt, real-time interaction with a television user, for example by displaying video content promptly upon request, the OS 230 is a real-time OS having specific functionality that is configured to streamline the operations of the processor 230 and limit the delay between receiving a user request and providing the requested action. In an embodiment, such a real time operating system 230 may be a scaled down version of the Microsoft® Windows® operating system. In such an embodiment, scaled down (or streamlined) means that certain functionalities of the operating system that are not essential to the operation of a television, such as email or word processing functions, are removed from the operating system. In another embodiment, the real time operating system may be a skeletal version of a Unix-based operating system.

For example, in one embodiment, the OS 230 is stored in flash memory 206. Upon a user request to power up the television, for example via the user control buttons 104 or the remote control interface 106, at least a portion of the real time OS 230 is loaded into a cache of the processor 230 so that the video content of a video data source selected at power up is promptly provided for display within a very short time of the user request (e.g., usually within 2-10 seconds of receiving the user request, and in a finely tuned system, less than 2 seconds). Additionally, the streamlined OS 230 can allow the television 100 to promptly respond to user-requested actions, such as to display video content promptly upon receiving such a request, and other types of user requests, such as a user request to change television channels or a user request to activate game play associated with video game data processed by the video game console modular card 146. As such, the television 100 can provide the traditional television experience in which changes in the video content displayed and/or the audio content output occur promptly in response to the user's input as one or more requests.

In an embodiment, the processor 202 includes the OS 230 and a statistical user channel tracking (SUCT) module 231. The processor 202 is programmed to maintain a running instance of the SUCT logic 231. The SUCT logic monitors usage patterns of the user and narrows the total channel package to a specific number of channels that are available in real time to a user. Once the SUCT logic 231 determines the channel information, the channel and content are preloaded from the flash memory 206 into the processor 202 at startup for quick access.

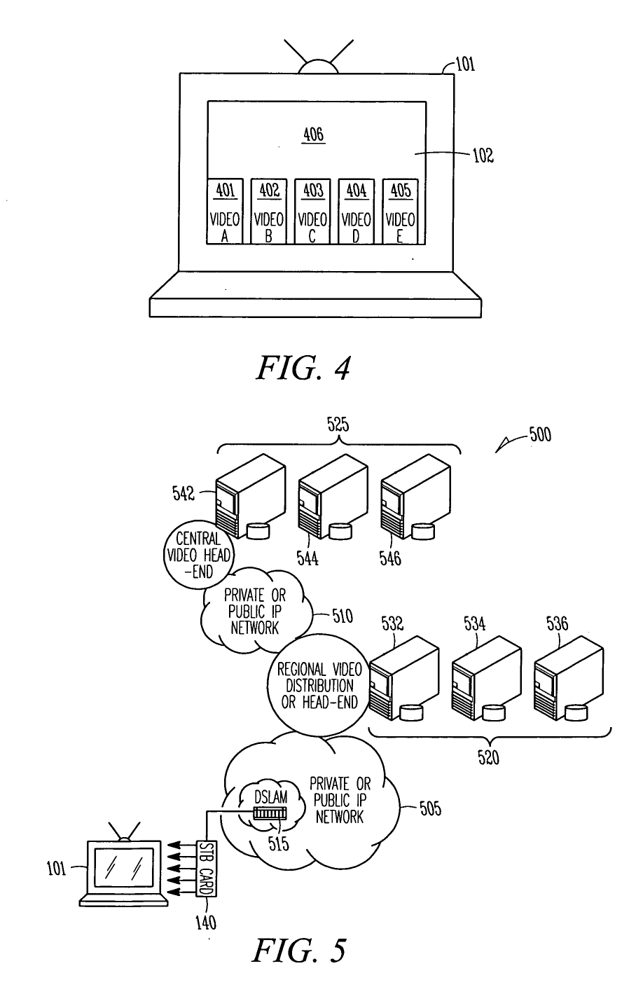

In an embodiment, the channel content, as determined by the SUCT logic 231, may be displayed at the display unit 102 by the display controller 212 in multiple low resolution images. As illustrated in FIG. 4, these multiple low resolution images (or secondary images) may be displayed as images 401, 402, 403, 404, and 405 on screen 102 of television 101. FIG. 4 also illustrates the display of a primary image 406 on the display 102. In an embodiment, a user may replace the primary image with one of the secondary images. In an embodiment, audio content may be limited to the primary image 406, or to one of the secondary images 401, 402, 403, 404, 405. In yet another embodiment, the processor 202 and OS 230 permit a user to select which image includes audio content. While FIG. 4 shows the low resolution images displayed in a single line across the bottom of screen 102, other user defined patterns would also be possible.

In connection with the display of multiple low resolution images, the processor 202 may also measure and track the bandwidth in the system in real time to determine the number of channels that may be displayed in the low resolution format. To do this, logic in the processor 202 may continuously communicate with an Internet provider's digital subscriber line access multiplexer 515 (DSLAM) to determine the available bandwidth. This bandwidth information may further be used to determine the distribution of the bandwidth among data applications, voice over IP applications, and video applications.

FIG. 5 illustrates an example of the connection of a television such as the one illustrated in FIGS. 1 and 2 to a network. Referring to FIG. 5, a system 500 includes a television 101, a set top box card 140, and one or more public or private networks 505 and 510. The network 505 to which the STB card 140 is connected includes a digital subscriber line access multiplexer (DSLAM) 515. The television 101 may be connected to regional video distribution servers 520 and/or central video distribution servers 525 via the networks 505 and 510. The regional server 520 may include a channel content application server 532, a content burst application server 534, and a user configuration preload database 536. Similarly, the central server 525 may include a channel content application server 542, a content burst application server 544, and an audience measurement and tracking server 546.

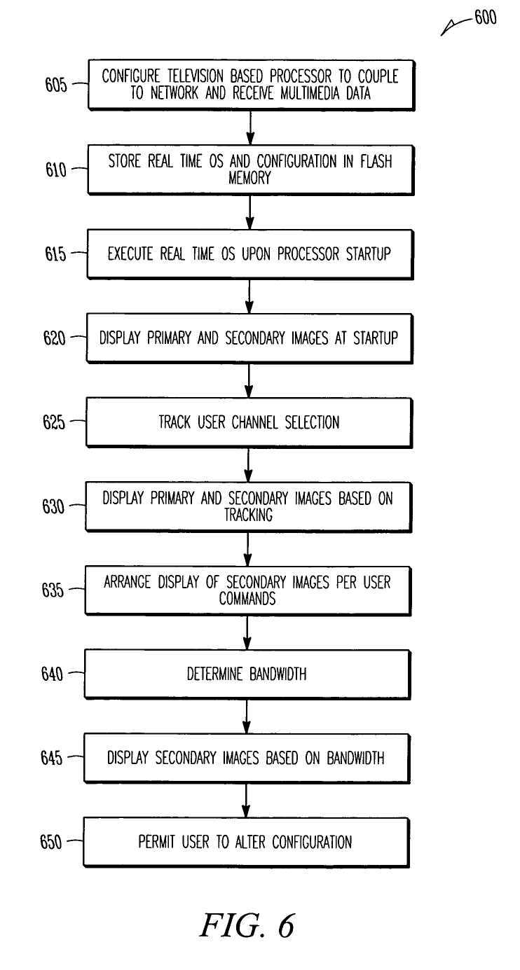

An example embodiment of an operation process 600 of a networked television system such as the system 100 illustrated in FIG. 1 is illustrated in FIG. 6. Referring specifically now to FIG. 6, at operation 605 a television-based processor is configured to couple to a packet-based network via a network interface and to receive multimedia data from the packet-based network. The processor is further configured at operation 610 to store at least a portion of a real time operating system and at least a portion of configuration parameters into a flash memory. The processor is further configured to execute the real time operating system in the flash memory upon processor startup at operation 615, and configured to display at least a portion of the multimedia data as a primary image and a plurality of secondary images on a television display upon a startup of the processor at operation 620.

FIG. 6 further illustrates that in an embodiment, the processor may be configured to track a channel selection methodology of a user at operation 625. At operation 630, the processor is configured to display the primary image and the plurality of secondary images based on this tracking. One example of such channel tracking is simply to keep a count of channels most frequently watched by the user, and display those most frequently watched channels as a primary image and several secondary images. As disclosed supra, these secondary images may be low resolution images. At operation 635, the processor is configured to permit a user to arrange the display of the secondary images. At operations 640 and 645 respectively, the processor is configured to determine the bandwidth of the network interface, and is further configured to determine the number of secondary images to display on the television display as a function of the bandwidth. The processor is also configured to allow a user to alter the system's configuration parameters at operation 650.

During operation, the various components of the television 100 communicate information via the busses 232, 234 in order to perform various multimedia related functions. For example, the communications processor 216 provides communications protocol specific processing for data received via the network interface 118 and for data to be transmitted on a packet based network via the network interface 118. Further, the communications processor 216 may implement one or more functions associated with, the Open Systems Interconnection (OSI) seven layer model or the Telecommunications Protocol/Internet Protocol (TCP/IP) stack. During operation, incoming data that is processed by the communications processor 216 can be routed to one or more of the components of the television 100 as appropriate. The DMA controller 210 can control access to the RAM 204 and/or the ROM 206 by the components of the television 100. Moreover, the overlay graphics generator 214 can generate overlay graphics that overlay the display graphics that are output to the display 102 by the display controller 212.

In a particular embodiment, the modular cards 140-146 may communicate information with each other and with other components of the television, for example, the processor 202 or the display controller 212, using the modular card receptacles 222-228 and the bus 234. For example, the wireless network interface modular card 142 or the network interface 118 may be used to receive/transmit audio data for the audio receiver modular card 144, or receive/transmit video game data and related information for the video game consol modular card 146. Alternatively, multimedia data or video game data may be received via one or more of the RF antenna interface 120, the IN component 112, of the DVD IN component 114. Further, video data that represents video content may be provided from the decoder modular card 140 or the video game console modular card 146 to the display controller 212 so that the video content is displayed by the display 102. Similarly, audio data representing audio content may be provided from the audio receiver modular card 144 to the audio output 220 for output of the audio content by one or more speakers of the television 100.

Referring to FIG. 3, an example embodiment of the multimedia decoder modular card 140 is illustrated in accordance with at least one embodiment of the present disclosure. In the example depicted, the multimedia decoder modular card 140 includes a modular card receptacle interface 302, an input buffer 304, a decryption module 305, a parser 306, a video decoder 308, a video output buffer 310, and an audio decoder 312 and an audio output buffer 314. In a particular embodiment, the incoming buffer 304 and the output buffers 310 and 314 may be implemented together as a single buffer.

During operation, incoming multimedia data that is to be processed by the decoder modular card 140 is buffered in the incoming buffer 304. In at least one embodiment, the multimedia data is part of an MPEG data stream. Accordingly, the parser 306 parses the multimedia data to identify the relevant video and/or audio data to be processed. Then, the parser 306 provides the video data to the video decoder 308. The video decoder 308 decodes, or transcodes, the video data and the resulting decoded/transcoded data can be stored in the outgoing video buffer 310 before being provided to the bus 234 (FIG. 2) for transmission to one or more components of the television 100. Similarly, the audio decoder 312 decodes or transcodes the audio data. Audio data is decoded/transcoded by the audio decoder 312 and the resulting decoded/transcoded audio data is buffered in the outgoing audio buffer 314 before being provided to the bus 234 for transmission to one or more other components of the television 100.

Alternatively, in one embodiment, the received multimedia data includes unencoded multimedia data. In this instance, the video decoder 308 also may provide a video encoder to encode the video data to generate encoded video data, for example MPEG data, and the audio decoder 312 may include an audio encoder to encode the audio data to generate encoded audio data.

In at least one embodiment, the received multimedia data is encrypted or otherwise protected to prevent unauthorized access to the multimedia content. Accordingly, in at least one embodiment, the integrated decoder modular card 140 further comprises a decryption module 305 to process the protected multimedia data to generate unprotected multimedia data using a decryption key 307 supplied by, for example, a provider of the protected multimedia data. In one embodiment, the decryption module 305 processes the protected multimedia data before it is provided to the parser 306. Alternatively, the decryption module 305 could be implemented at the output of the parser 306 or as part of the decoders 308 and 312.

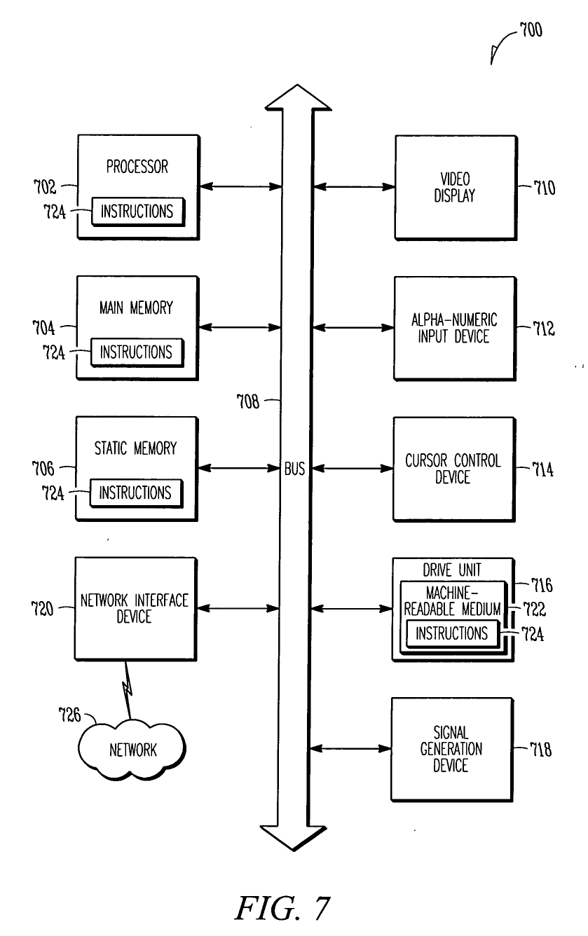

FIG. 7 shows a diagrammatic representation of a machine in the example form of a computer system 700 within which a set of instructions, for causing the machine to perform any one or more of the methodologies discusses herein, may be executed. In alternative embodiments, the machine operates as a standalone device or may be connected (for example networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular phone, a web appliance, a network router, switch, or bridge, or any machine capable of executing a set of web instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (for example a central processing unit (CPU), a graphics processing unit (GPU), or both), a main memory 704 and a static memory 706, which communicate with each other via a bus 708. The computer system 700 may further include a video display unit 710 (for example a liquid crystal display (LCD) or a cathode ray tube (CRT)). The computer system 700 also includes an alphanumeric input device 712 (for example a keyboard), a user interface (UI) navigation device 714 (for example a mouse), a disk drive unit 716, a signal generation device 718 (for example a speaker), and a network interface device 720.

The disk drive 716 includes a machine readable medium 722 on which is stored one or more sets of instructions and data structures (for example, software 724) embodying or utilized by any one or more of the methodologies or functions described herein. The software 724 may also reside, completely or at least partially, within the main memory 704 and/or within the processor 702 during execution thereof by the computer system 700, the main memory 704, and the processor 702 also constituting machine readable media.

The software 724 may further be transmitted or received over a network 726 via the network interface device 720 utilizing any one or a number of well-known transfer protocols (for example, HTTP).

While the machine readable medium 722 is shown in an example embodiment to be a single medium, the term “machine readable medium” should be taken to include a single medium or multiple media (for example, a centralized or distributed database, and/or associated caches and servers) that store the one or more sets of instructions. The term “machine readable medium” shall also be taken to include any medium that is capable of storing, encoding, or carrying a set of instructions for execution by the machine and that cause the machine to perform any one or more of the methodologies of the present invention, or that is capable of storing, encoding, or carrying data structures utilized by or associated with such a set of instructions. The term “machine readable medium” shall accordingly be taken to include, but not be limited to, solid state memories, optical and magnetic media, and carrier wave signals.

The above disclosed subject matter is to be considered illustrative and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A system comprising:
a STB processor;
a network interface coupled to the STB processor, the network interface connectable to a packet-based network;
a television display coupled to the STB processor;
a decoder coupled to the STB processor and the network interface;
a non-volatile memory coupled to the STB processor; and
a real time operating system to execute in the STB processor, the real time operating system having logic and configuration parameters, the logic configured to limit the delay between receiving a user request and providing a requested action.

2. The system of claim 1, wherein at least a portion of the real time operating system and the configuration parameters are stored in the non-volatile memory.

3. The system of claim 2, wherein the real time operating system and the configuration parameters in the non-volatile memory are operable to promptly startup the system.

4. The system of claim 1, wherein the STB processor comprises logic to track a channel selection methodology of a user of the system.

5. The system of claim 4, wherein results from the tracking of the channel selection methodology are stored in the non-volatile memory, and further wherein the results from the tracking are used to display a plurality of channels to the user at system startup.

6. The system of claim 5, wherein the display of channels comprises a primary image and a plurality of low resolution images.

7. The system of claim 6, wherein an arrangement of the display of the low resolution images is configurable by the user.

8. The system of claim 6, wherein the STB processor further comprises logic to permit a user to replace the primary image with one of the low resolution images.

9. The system of claim 1, wherein the network interface is coupled to a digital subscriber line access multiplexer, and further comprising logic in the STB processor to communicate with the digital subscriber line access multiplexer and to determine an available bandwidth of the system.

10. The system of claim 9, wherein the bandwidth is distributed among one or more of data applications, voice over IP applications, and video applications.

11. The system of claim 9, wherein the bandwidth is used to determine a number of low resolution images to be displayed on the television display.

12. The system of claim 1, wherein the non-volatile memory comprises a flash memory.

13. The system of claim 1, wherein the delay comprises less than 10 seconds.

14. The system of claim 1, wherein the delay comprises less than 2 seconds.

15. A method comprising:
configuring a television-based processor to couple to a packet-based network via a network interface and to receive multimedia data from the packet-based network;
configuring the processor to store at least a portion of a real time operating system and at least a portion of configuration parameters into a non-volatile memory; and
configuring the processor to execute the real time operating system in the non-volatile memory upon processor startup so that at least a portion of the multimedia data is promptly displayed as a primary image and a plurality of secondary images on a television display upon a startup of the processor.

16. The method of claim 15, further comprising:
configuring the processor to track a channel selection methodology of a user; and
further comprising configuring the processor to display the primary image and the plurality of secondary images based on the tracking.

17. The method of claim 15, wherein the secondary images comprise low resolution images.

18. The method of claim 15, further comprising configuring the processor to determine a bandwidth of the network interface.

19. The method of claim 18, further comprising configuring the processor to determine a number of the secondary images to display on the television display as a function of the bandwidth.

20. The method of claim 15, wherein the non-volatile memory comprises a flash memory.

21. A machine readable medium having instructions thereon, which when accessed by a machine performs a method comprising:
coupling a television-based processor to a packet-based network via a network interface and receiving multimedia data from the packet-based network;
storing at least a portion of a real time operating system and at least a portion of configuration parameters into a non-volatile memory; and
executing the real time operating system in the non-volatile memory upon processor startup so that at least a portion of the multimedia data is displayed as a primary image and a plurality of secondary images on a television display upon a startup of the processor.

22. The machine readable medium of claim 21, further comprising instructions for tracking a channel selection methodology of a user, and further comprising instructions for displaying the primary image and the plurality of secondary images based on the tracking.

23. The machine readable medium of claim 21, wherein the secondary images comprise low resolution images.

24. The machine readable medium of claim 21, further comprising instructions for determining a bandwidth of the network interface.

25. The machine readable medium of claim 24, further comprising instructions for determining a number of the secondary images to display on the television display as a function of the bandwidth.

26. The machine readable medium of claim 21, wherein the non-volatile memory comprises a flash memory.
